(19) United States
(12) Patent Application Publication
(10) Pub. No.: US 2003/0195072 A1
(43) Pub. Date: Oct. 16, 2003

(54) Composite sprocket

(76) Inventor: John D. Redmond, Littleton, CO (US)

Correspondence Address: Jeffrey Thurnau, The Gates Corporation, Mail Stop 31-4-1-A3, 900 S. Broadway, Denver, CO, 80209, US

(21) Appl. No.: 10/404,181

(22) Filed: Mar. 31, 2003

Related U.S. Application Data
(60) Provisional application No. 60/373,199, filed on Apr. 16, 2002.

(51) Int. Cl. F16H 55/30; F16H 55/06

(52) U.S. Cl. 474/161; 474/152

(57) ABSTRACT

A composite sprocket. The sprocket comprises an outer ring mounted to an inner hub. The outer ring has a profile, for example, a toothed profile. The toothed ring comprises a thermoset material such as polyurethane. The hub comprises any suitable metallic or non-metallic material sufficient for transmitting a torque from the ring to a shaft.

### REFERENCE TO RELATED APPLICATIONS

This application claims priority from U.S. application Ser. No. 60/373,199 filed Apr. 16, 2002.

### FIELD OF THE INVENTION

The invention relates to a sprocket and more particularly to a composite sprocket.

BACKGROUND OF THE INVENTION

Sprockets are well known in the art of power transmission. Two or more sprockets may be connected by a belt, chain or other flexible member suitable for bearing a tensile load. A sprocket may have a flat belt bearing surface or comprise transversely mounted teeth, gears or grooves.

Prior art sprockets are generally homogeneous, meaning the body of the sprocket and the teeth are made or cut out of the same material. The material may comprise metal, plastic, or other suitably tough material. In other instances the sprocket teeth are removable. This allows the teeth to be individually replaced, allowing the sprocket to remain in service during maintenance. The prior art sprockets of this type comprise metal such as steel and are used in severe duty applications such as on earth moving equipment.

Representative of the art is U.S. Pat. No. 4,752,281 (1988) to Lammers which discloses a drive sprocket assembly having a support hub and a plurality of replaceable teeth.

The prior art sprockets do not teach a removable wear surface made of a non-metallic material such as plastic. Further the prior art teeth are individually removable, they are not embodied in a single circular member.

What is needed is a composite sprocket having a nonmetallic ring for engaging a driven member. What is needed is a composite sprocket having a non-metallic ring having teeth. What is needed is a composite sprocket having a nonmetallic toothed ring engaged with a hub. What is needed is a composite sprocket having a thermoset toothed ring engaged with a metallic hub. The present invention meets these needs.

### SUMMARY OF THE INVENTION

The primary aspect of the present invention is to provide a composite sprocket having a non-metallic ring for engaging a driven member.

Another aspect of the invention is to provide a composite sprocket having a non-metallic ring having teeth.

Another aspect of the invention is to provide a composite sprocket having a non-metallic ring engaged with a hub.

Another aspect of the invention is to provide a composite sprocket having a thermoset toothed ring engaged with a metallic hub.

Other aspects of the invention will be pointed out or made apparent by the following description of the invention and the accompanying drawings.

The invention comprises a composite sprocket. The sprocket comprises an outer toothed ring mounted to an inner hub. The toothed ring comprises a thermoset such as polyurethane. The hub comprises any suitable metallic or non-metallic material sufficient for transmitting a torque to a shaft.

### BRIEF DESCRIPTION OF THE DRAWINGS

FIG. 1 is a cross-sectional view of the inventive sprocket.

FIG. 2 is a plan view of the inventive sprocket.

### DESCRIPTION OF THE PREFERRED EMBODIMENT OF THE INVENTION

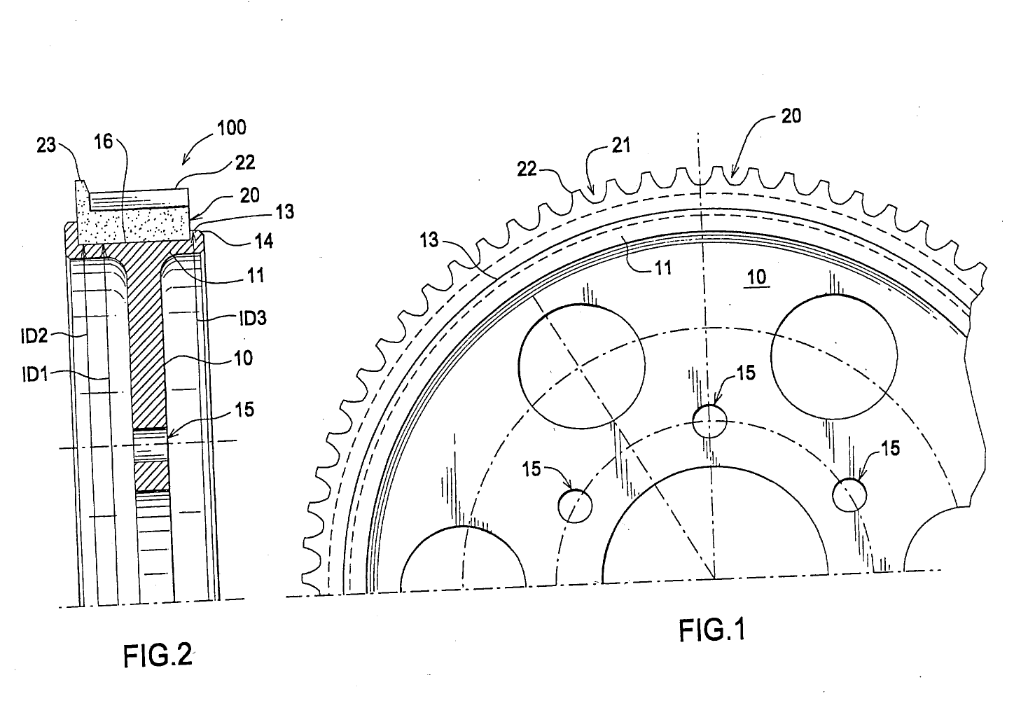

FIG. 1 is a cross-sectional view of the inventive sprocket. Composite sprocket 100 generally comprises hub 10 and ring 20.

Hub 10 has an outer rim 11. Outer rim 11 comprises shoulder 12 and shoulder 13. Hub may comprise any suitable material for transmitting a torque such as metallic or nonmetallic material. The preferred embodiment may utilize aluminum or steel, or their equivalents. Outer rim 11 also comprises a chamfer 14.

Circular member or ring 20 comprises a profile, for example, grooves 21 between teeth 22. Ring 20 may also comprise a flat or grooved profile as well. Ring 20 also comprises a shoulder 23 extending about a circumference on one side of the ring. Ring 20 typically would engage a driven member (not shown) in a mechanical system.

Ring 20 comprises a molded thermoset or thermoplastic such as polyurethane, polyamide, polystyrene, polyethylene and their equivalents. Use of a thermoset or thermoplastic material has the advantage of improving resistance to the effects of debris caught between a belt and ring 20. The ring is more compliant to partially absorb part of a debris penetrating force which otherwise would be absorbed solely by a belt in the case of a metal sprocket.

The ring is molded having a radius ID1. An outer surface 16 of outer rim 11 is fabricated with a radius ID2. Shoulder 13 has a radius ID3. In the preferred embodiment, ID1 is equal to or slightly less than ID2. Radius ID3 is slightly greater than ID1. Ring 20 may also comprise a metallic material.

To assemble the composite sprocket, ring 20 is heated as necessary in order to soften and expand the ring. Heating the ring expands the radius according to the coefficient of expansion of the ring material. Ring 20 is then pressed over shoulder 13, temporarily expanding radius ID1 equal to radius ID3. Ring 20 is then engaged with surface 16. Hub 10 is at ambient temperature. As ring 20 cools it shrinks, reducing ID1 to less than ID3, thereby mechanically locking ring 20 into hub 10. In order ease installation of the ring over shoulder 13, chamfer or beveled surface 14 facilitates pressing ring 20 over shoulder 13.

A metallic ring may also be installed in a like manner, that is by heating to partially expand the ring and then sliding it on the hub while the hub is maintained at an ambient temperature.

Surface 16 may be treated with an adhesive to bind ring 20 to hub 10. As an alternative, an interference fit may be created by making ID2 greater than ID1 in an ambient temperature condition. Either method of fixing the ring to the hub serves to lock the ring in place on the hub, thereby preventing it from moving relative to the hub while transmitting a torque, or, in the alternative, to allow the ring to slip a predetermined amount upon application of a torque.

Holes 15 accommodate bolts (not shown) for attaching the sprocket to a wheel, for example, to a motorcycle wheel.

FIG. 2 is a plan view of the inventive sprocket. Grooves 21 and teeth 22 can describe any profile known in the sprocket arts.

The inventive sprocket facilitates maintenance of the sprocket. Once the toothed profile has worn a predetermined amount, the outer ring 20 can be removed and replaced. This eliminates the necessity of replacing the entire sprocket, including removal of the sprocket from a shaft.

Use of a thermoplastic ring 20 also significantly reduces a sprocket weight. For example, an average density for high speed tool steel is ˜8.7 gm/cc, or 546 lb/ft³. An average density for polyurethane is ˜1.3 g/cc, or, 82 lb/ft³. This difference in density represents a significant weight reduction in a single composite pulley system, as well as a significant weight reduction in a system utilizing multiple composite pulleys.

Although a single form of the invention has been described herein, it will be obvious to those skilled in the art that variations may be made in the construction and relation of the parts without departing from the spirit and scope of the invention described herein.

I claim:

1. A sprocket comprising:
a hub; and
a substantially circular member engaged with the hub; and
the circular member having a profile.

2. The sprocket as in claim 1, wherein the circular member comprises a metallic material.

3. The sprocket as in claim 1, wherein the circular member comprises a non-metallic material.

4. The sprocket as in claim 3 wherein circular member further comprises a shoulder about a circumference.

5. The sprocket as in claim 3, wherein a radius of the circular member is less than a radius of the hub.

6. The sprocket as in claim 4, wherein the hub further comprises a first shoulder having a radius greater than a circular member radius.

7. The sprocket as in claim 6 further comprising:
a surface on the first shoulder for facilitating a circular member installation.

8. The sprocket as in claim 6, wherein the hub further comprises a second shoulder disposed opposite the first shoulder such that the circular member is contained between the first shoulder and the second shoulder.

9. The sprocket as in claim 7, wherein the surface describes a bevel.

10. The sprocket as in claim 8 wherein the non-metallic material comprises polyurethane.

11. The sprocket as in claim 10 having a toothed profile on the circular member.

12. A sprocket comprising:
a hub;
a substantially circular member engaged with the hub, the circular member having a profile;
the hub comprising a first shoulder having a radius greater than a circular member radius;
the hub comprising a second shoulder disposed opposite the first shoulder such that the circular member is contained between the first shoulder and the second shoulder; and
the circular member comprises polyurethane.

13. The sprocket as in claim 12 wherein the circular member comprises a profile.

14. The sprocket as in claim 13, wherein the profile comprises grooves and teeth.

15. The sprocket as in claim 12, wherein the circular member has a shrink fit on the hub.

16. The sprocket as in claim 12 attached to a motorcycle wheel.
